(19) United States
(12) Patent Application Publication
(10) Pub. No.: US 2010/0260386 A1
(43) Pub. Date: Oct. 14, 2010

(54) IMAGE PROCESSING APPARATUS AND CONTROL METHOD OF IMAGE PROCESSING APPARATUS

(75) Inventor: Yoshihito Machida, Sagamihara-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/750,876

(22) Filed: Mar. 31, 2010

(30) Foreign Application Priority Data
Apr. 8, 2009 (JP) 2009-094365

(51) Int. Cl. G06K 9/00

(52) U.S. Cl. 382/107

(57) ABSTRACT

An image processing apparatus for processing a moving image of a subject includes an input unit which accepts an input of a moving image of the subject, an analysis unit which analyzes a phase of a motion of the subject based on a frame image of the moving image, a determination unit which determines whether or not feature amount information of a frame image in phase with the analyzed phase is stored in a storage unit, a feature amount setting unit which sets the feature amount information in a frame image to be processed when it is determined based on the determination result of the determination unit that the feature amount information of the frame image in phase with the analyzed phase is stored in the storage unit, and an image processing unit which executes image processing for the frame image to be processed according to the feature amount information.

### BACKGROUND OF THE INVENTION

1. Field of the Invention

The present invention relates to an image processing apparatus and a control method of an image processing apparatus.

2. Description of the Related Art

Conventionally, various image correction techniques have been proposed to improve image data. As an example of the image correction technique, Japanese Patent Laid-Open No. 2000-101840 discloses a technique which extracts feature amounts from an image, and applies tone correction, sharpness correction, color balance correction, white balance correction, and exposure correction using the extracted feature amounts. The aforementioned image correction technique is expected to apply image correction not only to a still image but also to a moving image.

However, a processing speed requirement upon performing image processing for a moving image is often higher than that of image processing for a still image. For this reason, when an image correction technique used for a still image is applied intact to a moving image, it is difficult to obtain a processing speed high enough to implement moving image processing. When a simple image correction technique is applied for moving image processing, it is difficult for image correction to maintain sufficiently high precision, and stable image quality cannot be obtained.

### SUMMARY OF THE INVENTION

The present invention provides an image processing technique, which can assure stable image quality of a moving image after image processing while obtaining a processing speed high enough to implement image correction of the moving image.

According to one aspect of the present invention, there is provided an image processing apparatus for processing a moving image of a subject, comprising:
an input unit adapted to accept an input of a moving image of the subject;
an analysis unit adapted to analyze a phase of a motion of the subject based on a frame image of the moving image accepted by the input unit;
a determination unit adapted to determine based on the analysis result of the analysis unit whether or not feature amount information of a frame image in phase with the analyzed phase is stored in a storage unit;
a feature amount setting unit adapted to set the feature amount information in a frame image to be processed when it is determined based on the determination result of the determination unit that the feature amount information of the frame image in phase with the analyzed phase is stored in the storage unit; and
an image processing unit adapted to execute image processing for the frame image to be processed according to the feature amount information set by the feature amount setting unit.

According to another aspect of the present invention, there is provided a method of controlling an image processing apparatus for processing a moving image of a subject, comprising:
an input step of accepting an input of a moving image of the subject;
an analysis step of analyzing a phase of a motion of the subject based on a frame image of the moving image accepted in the input step;
a determination step of determining based on the analysis result in the analysis step whether or not feature amount information of a frame image in phase with the analyzed phase is stored in a storage unit;
a feature amount setting step of setting the feature amount information in a frame image to be processed when it is determined based on the determination result in the determination step that the feature amount information of the frame image in phase with the analyzed phase is stored in the storage unit; and
an image processing step of executing image processing for the frame image to be processed according to the feature amount information set in the feature amount setting step.

According to the present invention, stable image quality of a moving image after image processing can be assured while obtaining a processing speed high enough to implement image correction of the moving image.

Further features of the present invention will become apparent from the following description of exemplary embodiments (with reference to the attached drawings).

### BRIEF DESCRIPTION OF THE DRAWINGS

FIG. 1 is a block diagram showing the arrangement of an image processing apparatus according to the first embodiment;

FIG. 2 is a flowchart showing the processing sequence of the image processing apparatus;

FIG. 3 is a block diagram showing the arrangement of a feature amount setting unit;

FIG. 4 is a flowchart showing the processing sequence of the feature amount setting unit;

FIGS. 5A and 5B are tables showing examples of feature amount information;

FIG. 6 is a view showing an example of a current frame image to be analyzed by the feature amount setting unit;

FIGS. 7A and 7B are graphs showing examples of a histogram and accumulated histogram of the current frame image to be analyzed by a current frame feature amount extraction unit;

FIG. 8 is a block diagram showing the arrangement of an image processing unit;

FIG. 9 is a flowchart showing the processing sequence of the image processing unit;

FIG. 10 is a graph showing an example of an LUT generated by the image processing unit;

FIG. 11 is a block diagram showing the arrangement of an image processing apparatus according to the second embodiment;

FIG. 12 is a flowchart showing the processing sequence of the image processing apparatus;

FIG. 13 is a block diagram showing the arrangement of a feature amount setting unit;

FIG. 14 is a flowchart showing the processing sequence of the feature amount setting unit;

FIGS. 15A to 15C are tables showing examples of feature amount information;

FIG. 16 is a block diagram showing the arrangement of an image processing apparatus according to the third embodiment;

FIG. 17 is a flowchart showing the processing sequence of the image processing apparatus;

FIG. 18 is a block diagram showing the arrangement of a feature amount setting unit; and

FIG. 19 is a flowchart showing the processing sequence of the feature amount setting unit.

### DESCRIPTION OF THE EMBODIMENTS

### First Embodiment

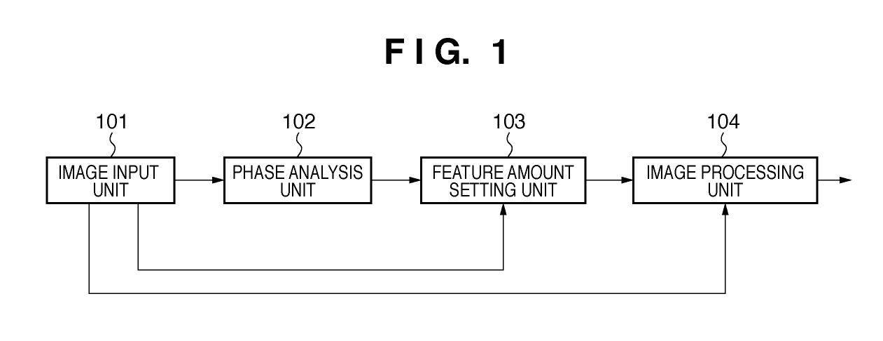

An overview of an image processing apparatus according to the first embodiment of the present invention will be described below with reference to the block diagram shown in FIG. 1. An image input unit 101 accepts an external moving image input. A phase analysis unit 102 receives frame images which form a moving image from the image input unit 101, and analyzes a phase of a motion of a subject in a frame image to be processed (to be referred to as a “current frame image” hereinafter). A feature amount setting unit 103 receives the current frame image from the image input unit 101 and the phase analysis result analyzed by the phase analysis unit 102, and sets feature amounts of the current frame image. An image processing unit 104 receives the current frame image from the image input unit 101 and the feature amounts of the current frame set by the feature amount setting unit 103, and applies image processing to the current frame image.

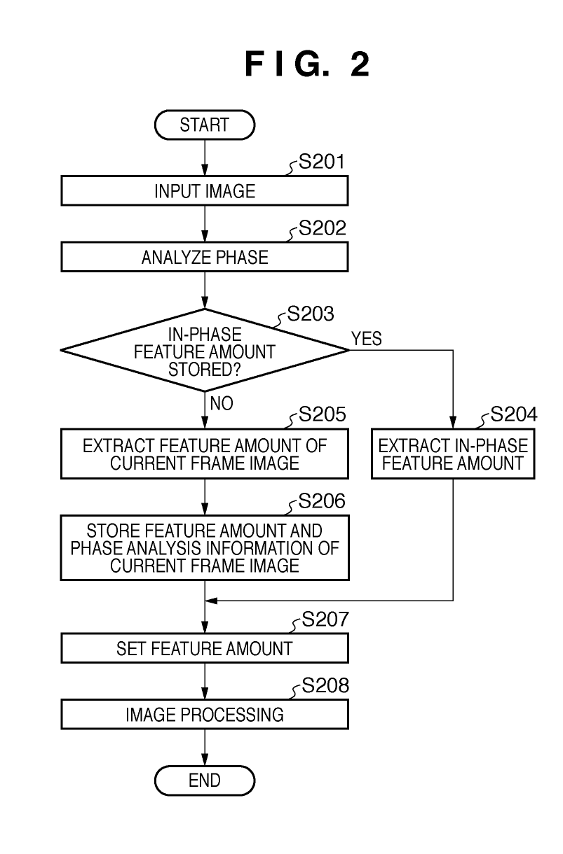

A series of processes to be executed by the image processing apparatus according to the first embodiment will be described below with reference to the flowchart shown in FIG. 2. Note that a control program of the image processing apparatus allows a computer to execute the processing sequence shown in the flowchart of FIG. 2. In step S201, the image input unit 101 accepts an input of the current frame image. In step S202, the phase analysis unit 102 receives the current frame image from the image input unit 101, and analyzes the phase of a motion of a subject. Note that the method of analyzing the phase of the motion of the subject can use, for example, a method disclosed in Japanese Patent Laid-Open No. 2004-000411. The method of analyzing the phase of the motion of the subject is not limited to such specific method, and any other methods of analyzing the phase can be used.

The feature amount setting unit 103 determines in step S203 whether or not feature amounts set in phase with the current frame (in-phase feature amounts) have been stored from the imaging start timing until a timing before the acquisition timing of the current frame image.

If in-phase feature amounts have been stored from the imaging start timing until a timing before the acquisition timing of the current frame image (Yes in S203), the feature amount setting unit 103 extracts the feature amounts (S204). Since the in-phase feature amounts which have already been set are used without executing processing for extracting feature amounts for each frame, the processing speed can be increased. After completion of the process in step S204, the process advances to step S207.

Next, if no in-phase feature amounts have been stored from the imaging start timing until a timing before the acquisition timing of the current frame image (No in S203), the feature amount setting unit 103 extracts feature amounts of the current frame image (S205). If the feature amounts of the current frame are extracted, the feature amount setting unit 103 stores phase analysis information together with the feature amounts of the current frame in step S206. In step S207, the feature amount setting unit 103 sets the feature amounts extracted in step S205. Note that details of the feature amount setting method by the feature amount setting unit 103 will be described later. In step S208, the image processing unit 104 applies image processing to the current frame image based on the feature amounts set in step S207. Note that details of the image processing method by the image processing unit 104 will be described later. By executing the aforementioned processes in steps 5201 to S208, the series of processes of the image processing apparatus are complete.

### Feature Amount Setting Unit 103

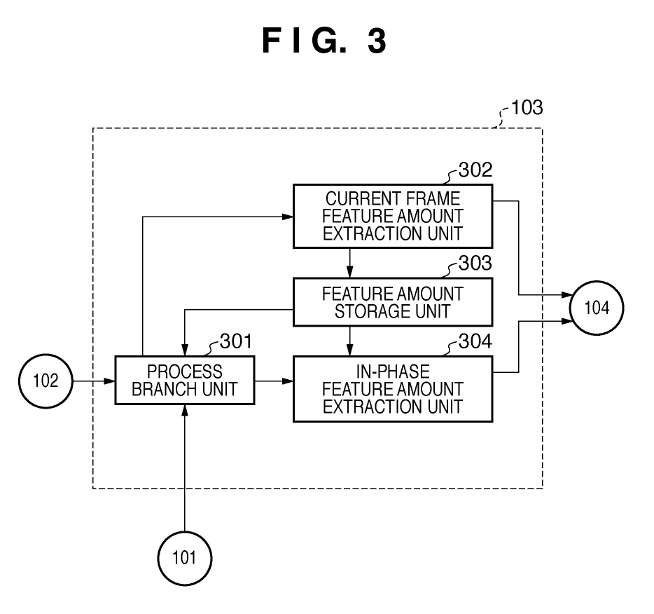

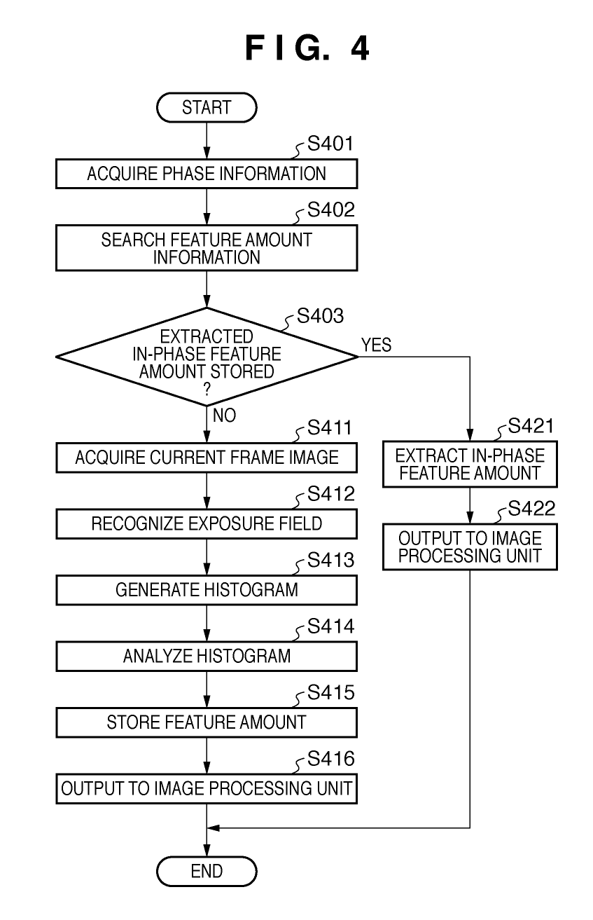

A series of processes by the feature amount setting unit 103 will be described in detail below with reference to the block diagram shown in FIG. 3 and the flowchart shown in FIG. 4. A process branch unit 301 distributes (branches) processes to be executed by the feature amount setting unit 103 based on the phase information received from the phase analysis unit 102. A current frame feature amount extraction unit 302 extracts feature amounts of the current frame image. A feature amount storage unit 303 stores the feature amounts extracted by the current frame feature amount extraction unit 302. An in-phase feature amount extraction unit 304 extracts feature amounts set in an image in phase with the current frame.

A series of processes executed by the feature amount setting unit 103 will be described below with reference to the flowchart shown in FIG. 4. At the timing of completion of steps S401 to S403 in FIG. 4, either steps 5411 to 5416 to be performed by the current frame feature amount extraction unit 302 or steps S421 and S422 to be performed by the in-phase feature amount extraction unit 304 are executed.

In step S401, the process branch unit 301 receives phase information at the acquisition timing of the current frame image from the phase analysis unit 102. In step S402, the process branch unit 301 searches for feature amount information in the feature amount storage unit 303 to determine whether or not feature amounts have been extracted from an image in phase with the current frame image from the imaging start timing until a timing before the acquisition timing of the current frame image. In step S403, the process branch unit 301 issues an operation instruction to the current frame feature amount extraction unit 302 or in-phase feature amount extraction unit 304 based on the determination result in step S402.

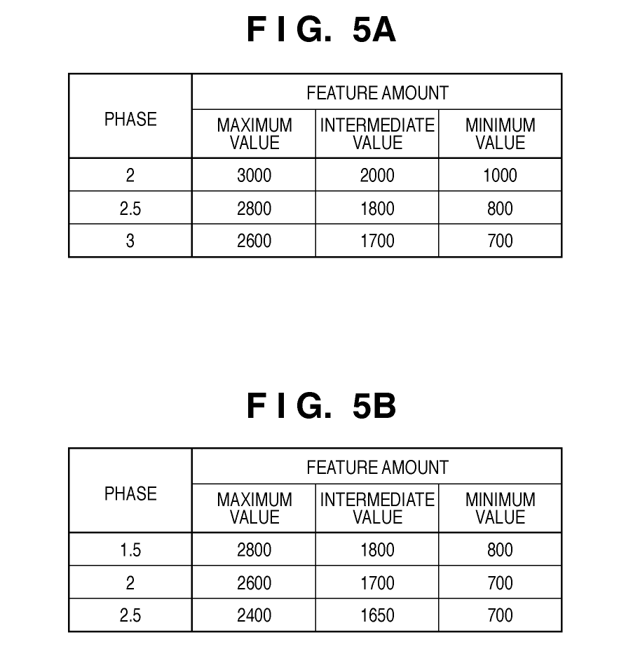

FIGS. 5A and 5B show examples of feature amount information in the feature amount storage unit 303. Assuming that the phase of the current frame is 3 [rad], [in-phase feature amount stored] is determined in case of FIG. 5A, and the process branch unit 301 supplies an operation instruction to the in-phase feature amount extraction unit 304. On the other hand, [no in-phase feature amount stored] is determined in case of FIG. 5B, and the process branch unit 301 supplies an operation instruction to the current frame feature amount extraction unit 302. Note that feature amount information exemplified in FIGS. 5A and 5B has a configuration having a minimum value, intermediate value, and maximum value in correspondence with phase information. The example of the feature amount information is not limited to such specific example. In addition, the feature amount information may have all kinds of available information as feature amounts (for example, the information may include only a representative value in correspondence with phase information).

A series of processes in steps S411 to S416 performed by the current frame feature amount extraction unit 302 will be described below. Upon reception of the operation instruction from the process branch unit 301 (No in S403), the current frame feature amount extraction unit 302 acquires the current frame image from the image input unit 101 in step S411. In step S412, the current frame feature amount extraction unit 302 recognizes an exposure field irradiated with X-rays. Note that various methods about exposure field recognition have been proposed. For example, methods proposed by Japanese Patent Laid-Open Nos. 2000-271107 and 2003-33968 may be used. In step S413, the current frame feature amount extraction unit 302 generates a histogram of an image within the exposure field.

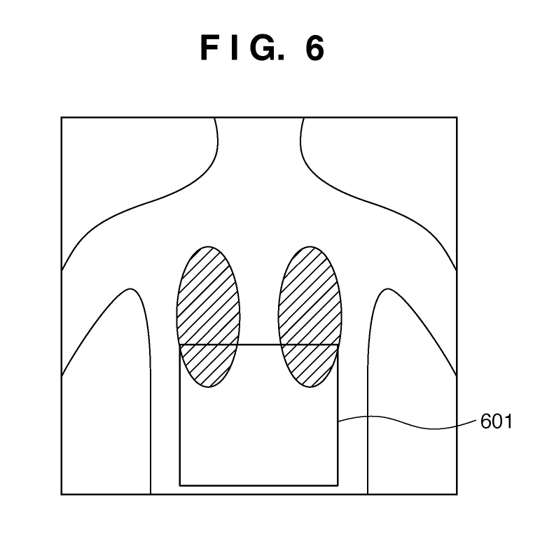

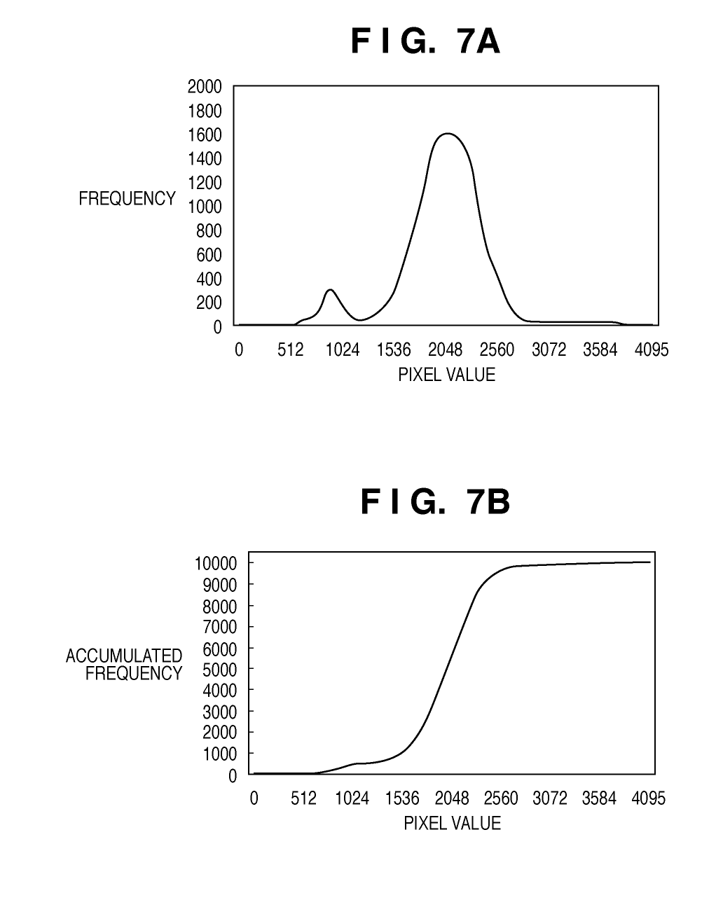

In step S414, the current frame feature amount extraction unit 302 analyzes the generated histogram and extracts feature amounts. An example of histogram analysis will be described below with reference to FIG. 6 and FIGS. 7A and 7B. FIG. 6 shows the current frame image. Reference numeral 601 in FIG. 6 denotes an exposure field irradiated with X-rays. This image has the number of tones=4096 and a size=100×100 (mm) in the exposure field. A histogram within the exposure field of this image is generated (FIG. 7A). Then, an accumulated histogram (FIG. 7B) is generated from this histogram, and first pixel values whose accumulated frequencies are 5% or more, 50% or more, and 95% or more of the total frequency are respectively calculated as a minimum value, intermediate value, and maximum value. Note that the histogram analysis in FIGS. 7A and 7B is merely an example. In addition, various other methods such as a method of setting a mode value of the histogram as a representative value, i.e., a feature amount may be used.

In step S415, the current frame feature amount extraction unit 302 stores the extracted feature amounts in the feature amount storage unit 303 together with the phase information. In step S416, the current frame feature amount extraction unit 302 outputs the extracted feature amounts to the image processing unit 104, thus ending the processing. Note that the feature amount extraction method by the current frame feature amount extraction unit 302 adopts a method based on histogram analysis. However, the present invention is not limited to such specific example. For example, a method of selecting a region 10% of the exposure field size from the center of the exposure field and calculating an average value of that region may be applied.

A series of processes in steps S421 and S422 performed by the in-phase feature amount extraction unit 304 will be described below. Upon reception of the operation instruction from the process branch unit 301 (Yes in S403), the in-phase feature amount extraction unit 304 acquires feature amounts in phase with the current frame image from the feature amount storage unit 303 in step S421. Next, in step S422 the in-phase feature amount extraction unit 304 outputs the feature amounts acquired in step S421 to the image processing unit 104, thus ending the processing. By executing the processes in steps S401 to S422 as needed, the feature amount setting processing by the feature amount setting unit 103 is complete.

### Arrangement of Image Processing Unit 104

The arrangement of the image processing unit 104 will be described in detail below with reference to the block diagram shown in FIG. 8. The image processing unit 104 executes image processing for a frame image according to information of the feature amounts set by the feature amount setting unit 103. The image processing includes at least one of tone processing, sharpening processing used to sharpen the edge of a subject image, and noise suppression processing, but the present invention is not limited to such specific processes.

A tone processor 801 receives the current frame image from the image input unit 101 and the feature amounts from the feature amount setting unit 103, and performs tone processing. A sharpening processor 802 receives the image after the tone processing from the tone processor 801, and the feature amounts from the feature amount setting unit 103, and performs sharpening processing. A noise suppression processor 803 receives the image after the sharpening processing from the sharpening processor 802 and the feature amounts from the feature amount setting unit 103, and performs noise suppression processing.

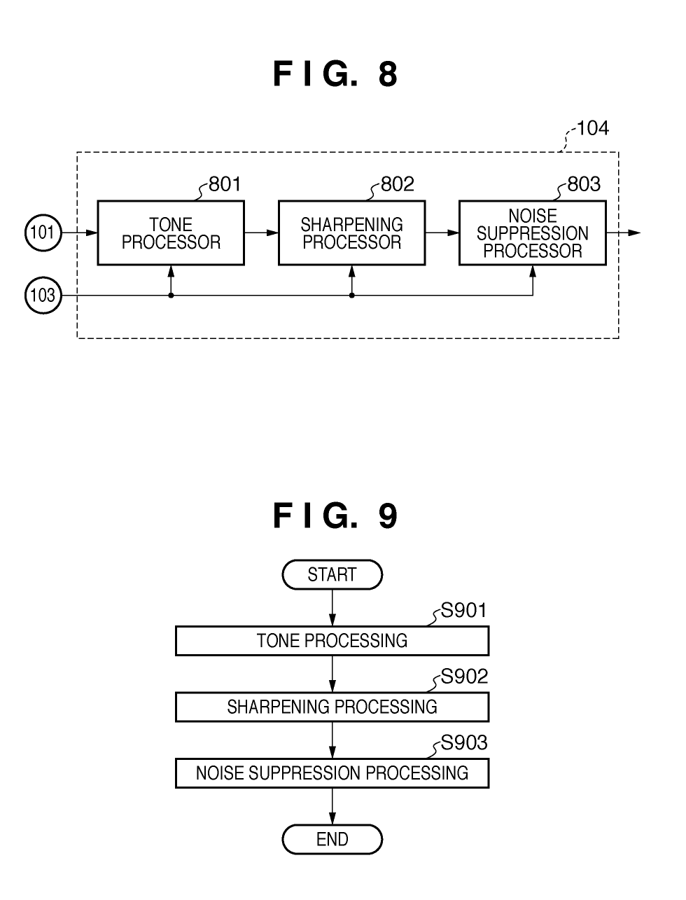

A series of processes to be executed by the image processing unit 104 will be described below with reference to FIG. 9. The tone processing method (S901) performed by the tone processor 801 will be described first. In step S901, the tone processor 801 performs the tone processing based on the current frame image acquired from the image input unit 101 and the feature amounts acquired from the feature amount setting unit 103. An example of the tone processing method by the tone processor 801 will be described below. The tone processor 801 generates a lookup table (LUT) required to convert pixel values of the current frame image into those after the tone conversion processing, based on the feature amounts (minimum value, intermediate value, and maximum value), and target pixel values and fixed value conversion values, which are set in advance.

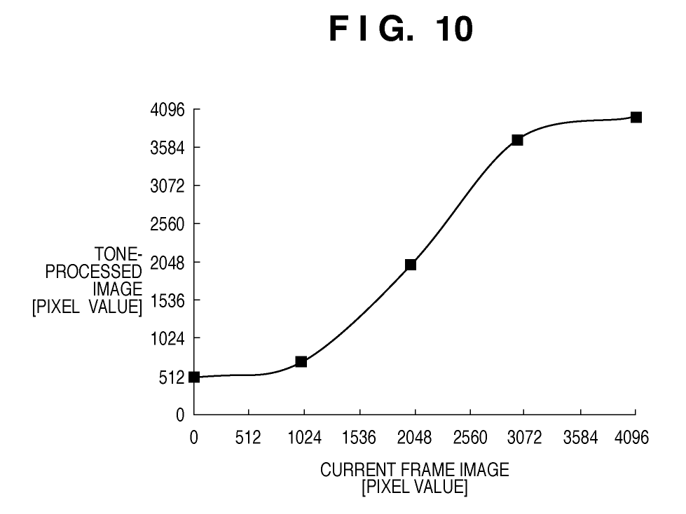

The LUT will be exemplarily described below with reference to FIG. 10. In this LUT, points which respectively convert a pixel value “0” of the current frame image into “512” and “4095” into “4095” are set. Furthermore, points which respectively convert the minimum value (for example, 1000) as the feature amount into “700”, the intermediate value (for example, 2000) into “2000”, and the maximum value (for example, 3000) into “3700” are set. Data between neighboring set points are calculated by spline interpolation.

The tone processor 801 converts respective pixel values of the current frame image with reference to the LUT, thereby generating an image after the tone processing. In the above example, as the tone processing method by the tone processor 801, the method of generating the LUT by associating the feature amounts, i.e., the minimum value, intermediate value, and maximum value with the target pixel values has been exemplified. However, the tone processing method is not limited to such specific method. For example, the following method may be adopted. That is, in this method, an image is decomposed based on spatial frequencies to generate a plurality of images having various spatial frequency bands, and conversion coefficients or LUTs for tone conversion can be generated based on the feature amounts in correspondence with the plurality of images. Then, conversion processing is applied to the respective images, and one image is reconstructed using the plurality of images, thus attaining tone conversion. In this way, various other methods that allow tone processing can be applied.

The sharpening processing method (S902) performed by the sharpening processor 802 will be described below. The sharpening processor 802 performs the sharpening processing based on the tone-processed image acquired from the tone processor 801 and the feature amounts acquired from the feature amount setting unit 103 (S902). An example of the sharpening processing by the sharpening processor 802 will be described below. The sharpening processor 802 decides emphasis coefficients according to the feature amounts (minimum value, maximum value) acquired from the feature amount setting unit 103. At this time, the emphasis coefficients may be increased with decreasing difference between the minimum value and maximum value. This is because when the difference between the minimum value and maximum value is small, since a dynamic range is narrow, it is difficult even for a high-spatial frequency region to give high contrast. Next, the sharpening processor 802 applies average value filter processing of 3 pixels×3 pixels to the image after the tone processing to generate a blur image. Then, the sharpening processor 802 performs difference processing for subtracting the blur image from the image after the tone processing to generate a difference image. Then, the sharpening processor 802 multiplies this difference image by the coefficients, and adds the processed image to the tone-processed image, thereby generating a sharpening-processed image. In the above example, as the sharpening processing method by the sharpening processor 802, the method of generating the coefficients to be multiplied with the difference image according to the feature amounts has been exemplified. However, the sharpening processing method is not limited to such specific method. For example, the following method may be adopted. That is, in this method, an image is decomposed based on spatial frequencies to generate a plurality of images having various spatial frequency bands, and conversion coefficients or LUTs can be generated based on the feature amounts in correspondence with the plurality of images. Then, conversion processing is applied to the respective images, and one image is reconstructed using the plurality of images, thus attaining sharpening processing. In this way, various other methods that allow sharpening processing can be applied.

The noise suppression processing method (S903) by the noise suppression processor 803 will be described below. The noise suppression processor 803 performs the noise suppression processing based on the sharpening-processed image acquired from the sharpening processor 802, and the feature amounts acquired from the feature amount setting unit 103 (S903). An example of the noise suppression processing by the noise suppression processor 803 will be described below. The noise suppression processor 803 decides a smoothing filter size according to the feature amount (minimum value) acquired from the feature amount setting unit 103. At this time, smoothing coefficients may be increased with decreasing minimum value. This is because when the minimum value is small, since the dose is small, an image includes a relatively large number of noise components. Next, the noise suppression processor 803 applies smoothing filter processing to the sharpening-processed image using the decided filter size to generate an image that has undergone the noise suppression processing. In the above example, as the noise suppression processing method by the noise suppression processor 803, the method of deciding the smoothing filter size according to the feature amount has been exemplified. However, the noise suppression processing method is not limited to such specific method. For example, the following method may be adopted. That is, in this method, an image is decomposed based on spatial frequencies to generate a plurality of images having various spatial frequency bands, and conversion coefficients or LUTs can be generated based on the feature amounts in correspondence with the plurality of images. Then, conversion processing is applied to the respective images, and one image is reconstructed using the plurality of images, thus attaining noise suppression processing. In this way, various other methods that allow noise suppression processing can be applied.

This embodiment has exemplified the method of sequentially executing three processes, i.e., the tone processing, sharpening processing, and noise suppression processing as the image processing method in the image processing unit 104. In addition, a method of executing the three processes when the feature amounts obtained by the in-phase feature amount extraction unit 304 are used, and executing only the tone processing when the feature amounts obtained by the current frame feature amount extraction unit 302 are used may be adopted. When this method is used, the load on arithmetic processing required upon execution of the image processing is reduced against an increase in load on arithmetic processing required upon extraction of the feature amounts of the current frame. Thus, the arithmetic volume of the overall image processing apparatus can be suppressed, thus speeding up the processing even when complicated image analysis is done. In addition, a method of parallelly operating the tone processing, sharpening processing, and noise suppression processing, a method which uses the feature amounts in only the tone processing, and fixed values in other processes may be used. Also, combinations and processing orders of the three processes can be changed. By executing the series of processes in steps S901 to S903, the image processing by the image processing unit 104 is complete.

According to this embodiment, a moving image that has undergone the image processing can have stable image quality while obtaining a processing speed high enough to implement the image processing of the moving image.

### Second Embodiment

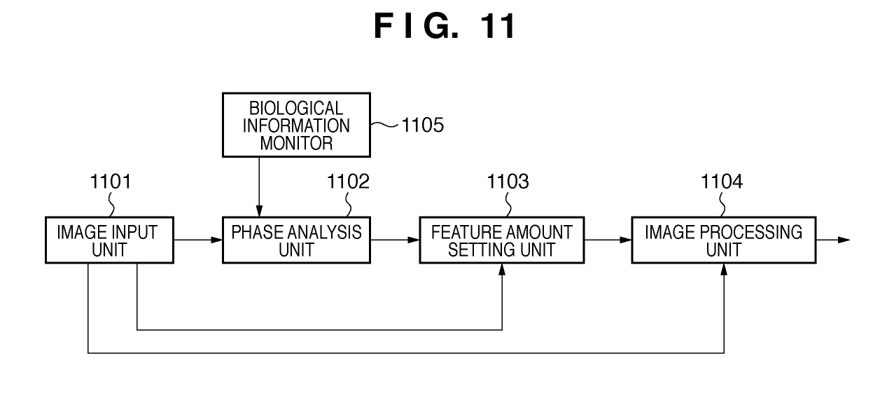

An overview of an image processing apparatus according to the second embodiment of the present invention will be described below with reference to the block diagram shown in FIG. 11. An image input unit 1101 accepts an external moving image input. A phase analysis unit 1102 receives frame images which form a moving image from the image input unit 1101, and analyzes a phase of a motion of a subject in a frame image to be processed (current frame image). A feature amount setting unit 1103 receives the current frame image from the image input unit 1101 and the phase analysis result from the phase analysis unit 1102, and sets feature amounts of the current frame image. An image processing unit 1104 receives the current frame image from the image input unit 1101 and the feature amounts of the current frame from the feature amount setting unit 1103, and applies image processing to the current frame image. A biological information monitor 1105 serves as a monitor unit which monitors biological information of a subject.

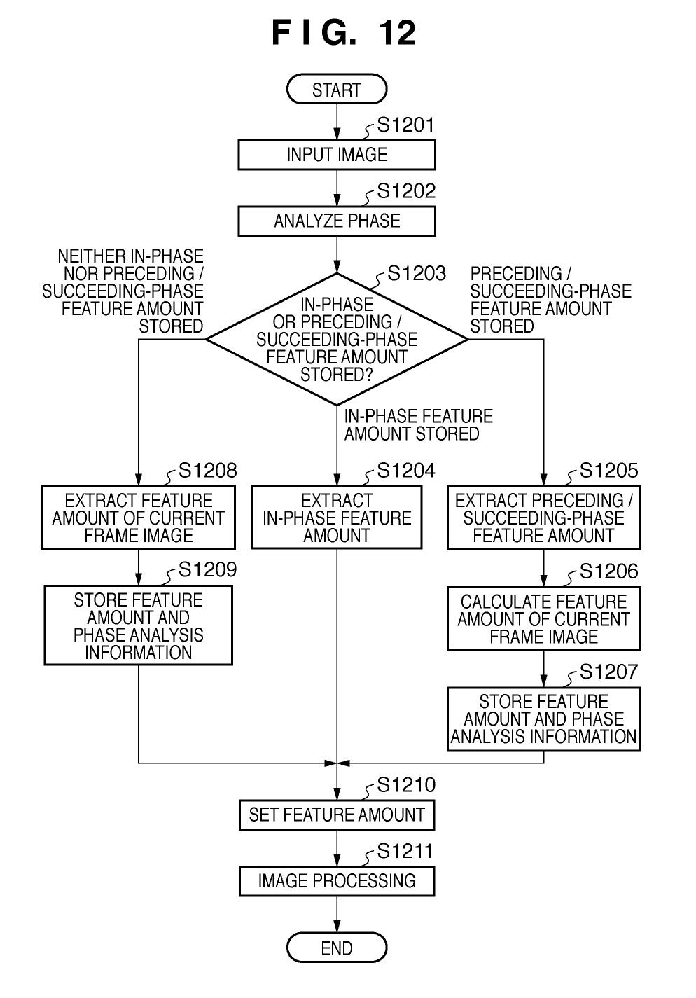

A series of processes to be executed by the image processing apparatus according to the second embodiment will be described below with reference to the flowchart shown in FIG. 12. Note that a control program of the image processing apparatus allows a computer to execute the processing sequence shown in the flowchart of FIG. 12. In step S1201, the image input unit 1101 accepts an input of the current frame image. In step S1202, the phase analysis unit 1102 receives the current frame image from the biological information monitor 1105, and analyzes the phase of an observation portion. The analysis result of the phase of the observation portion will also be referred to as phase analysis information hereinafter. As the method of analyzing the phase of the observation portion, for example, methods used in Japanese Patent Laid-Open Nos. 07-255717 and 2005-111151 may be applied. The method of analyzing the phase of the observation portion is not limited to these specific methods, and any other methods of analyzing the phase of the observation portion can be used.

The feature amount setting unit 1103 determines in step S1203 whether or not feature amounts set in phase with the current frame (in-phase feature amounts) or those set in correspondence with a preceding/succeeding phase with respect to the phase of the observation portion of interest (preceding/succeeding-phase feature amounts) have been stored from the imaging start timing until a timing before the acquisition timing of the current frame image. If in-phase feature amounts have been stored from the imaging start timing until a timing before the acquisition timing of the current frame image, the feature amount setting unit 1103 extracts the feature amounts in step S1204. If preceding/succeeding-phase feature amounts have been stored from the imaging start timing until a timing before the acquisition timing of the current frame image, the feature amount setting unit 1103 extracts the feature amounts in step S1205. In step S1206, the feature amount setting unit 1103 calculates feature amounts of the current frame image using the preceding/succeeding-phase feature amounts. In step S1207, the feature amount setting unit 1103 stores the calculated feature amounts of the current frame image together with its phase analysis information. Since the in-phase or preceding/succeeding-phase feature amounts which have already been set are used without executing the processing for extracting feature amounts for each frame, the processing speed can be increased.

On the other hand, if neither in-phase feature amounts nor preceding/succeeding-phase feature amounts have been stored from the imaging start timing until a timing before the acquisition timing of the current frame image, the feature amount setting unit 1103 extracts feature amounts of the current frame image in step S1208. In step S1209, the feature amount setting unit 1103 stores the phase analysis information together with the feature amounts of the current frame extracted in previous step S1208.

In step S1210, the feature amount setting unit 1103 sets the extracted feature amounts. Note that details of the feature amount setting method by the feature amount setting unit 1103 will be described later. In step S1211, the image processing unit 1104 applies image processing to the current frame image based on the set feature amounts. As for details of the image processing method by the image processing unit 1104, the same method as that by the image processing unit 104 of the first embodiment can be used. By executing the aforementioned processes in steps S1201 to S1211, the series of processes of the image processing apparatus are complete.

### Feature Amount Setting Unit 1103

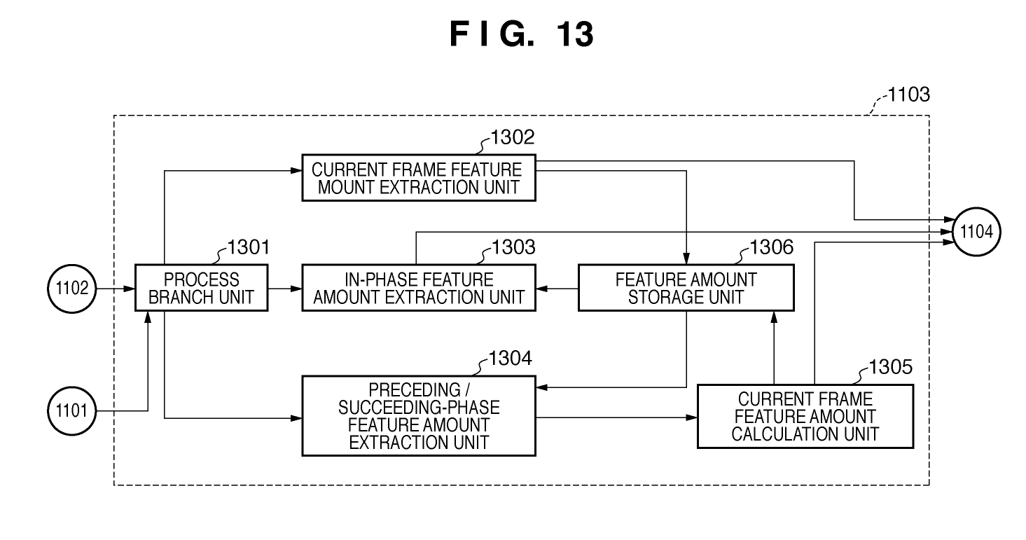

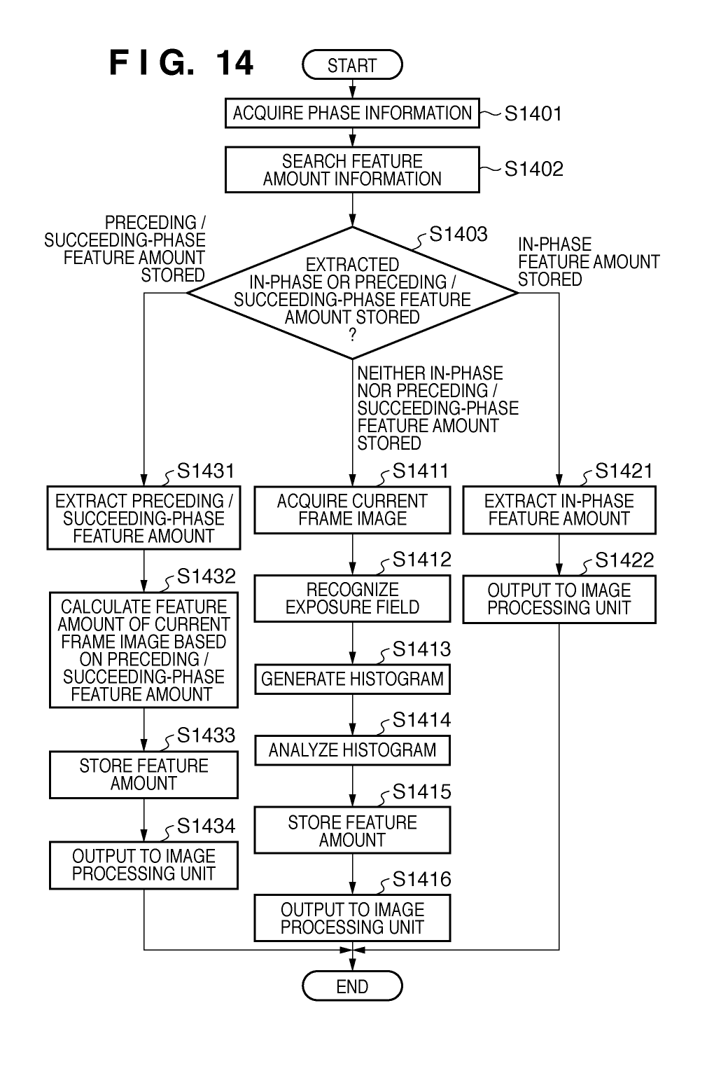

A series of processes by the feature amount setting unit 1103 will be described in detail below with reference to the block diagram shown in FIG. 13 and the flowchart shown in FIG. 14. A process branch unit 1301 distributes (branches) processes to be executed by the feature amount setting unit 1103 based on the phase information received from the phase analysis unit 1102. A current frame feature amount extraction unit 1302 extracts feature amounts of the current frame image. An in-phase feature amount extraction unit 1303 extracts feature amounts set in an image in phase with the current frame. A preceding/succeeding-phase feature amount extraction unit 1304 extracts feature amount set in an image having a preceding/succeeding phase of the current frame. A current frame feature amount calculation unit 1305 calculates feature amounts of the current frame image based on the feature amounts extracted from the preceding/succeeding-phase image. A feature amount storage unit 1306 stores the feature amounts obtained by the current frame feature amount extraction unit 1302 and current frame feature amount calculation unit 1305.

A series of processes executed by the feature amount setting unit 1103 will be described below with reference to the flowchart shown in FIG. 14. At the timing of completion of steps S1401 to S1403 in FIG. 14, the process advances to one of steps S1411, S1421, and S1431. The current frame feature amount extraction unit 1302 executes processes in steps S1411 to S1416. The in-phase feature amount extraction unit 1303 executes processes in steps S1421 and S1422. The preceding/succeeding-phase feature amount extraction unit 1304 and current frame feature amount calculation unit 1305 execute processes in steps S1431 to S1434. Since the processes in steps S1411 to S1416 and those in steps S1421 and S1422 are the same as those in steps S411 to S416 and those in steps S421 and S422 described in the first embodiment, a description thereof will not be repeated.

In step S1401, the process branch unit 1301 receives phase information at the acquisition timing of the current frame image from the phase analysis unit 1102. In step S1402, the process branch unit 1301 searches feature amount information stored in the feature amount storage unit 1306. The process branch unit 1301 determines whether or not feature amounts have been extracted from an image in phase with the current frame image or from an image having a preceding/succeeding phase of the current frame image from the imaging start timing until a timing before the acquisition timing of the current frame image. In step S1403, the process branch unit 1301 issues an operation instruction to one of the current frame feature amount extraction unit 1302, in-phase feature amount extraction unit 1303, and preceding/succeeding-phase feature amount extraction unit 1304 based on the determination result in step S1402.

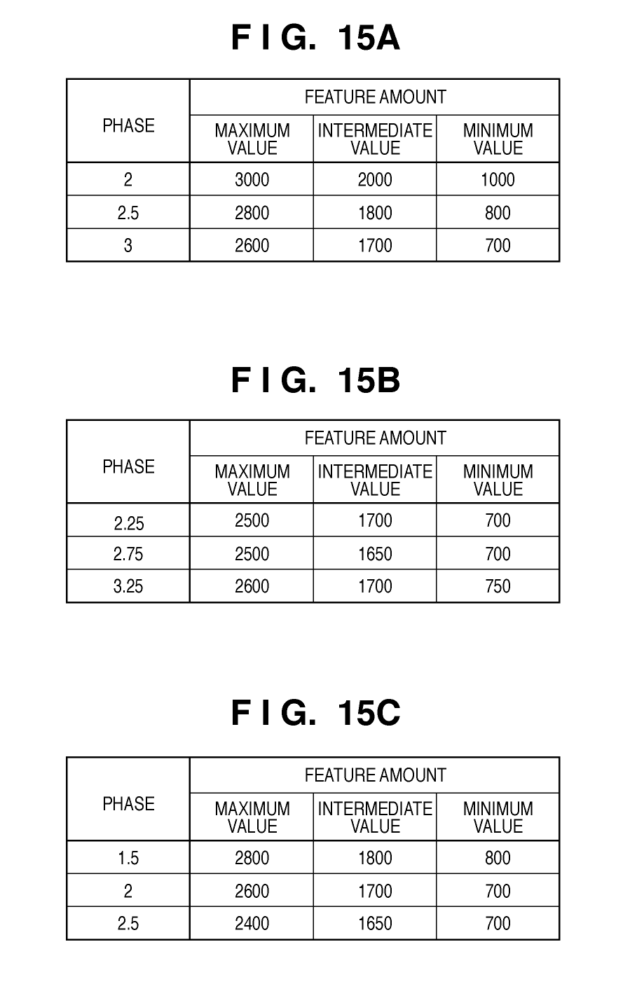

Feature amount information in the feature amount storage unit 1306 will be exemplarily described below with reference to FIGS. 15A to 15C. Assuming that the phase of the current frame is 3 [rad], [in-phase feature amount stored] is determined in case of FIG. 15A, and the process branch unit 1301 supplies an operation instruction to the in-phase feature amount extraction unit 1303. When information in phase with the phase (3 [rad]) of the current frame is not stored, a phase falling within a predetermined threshold range with respect to the phase (3 [rad]) of the current frame is determined as a preceding/succeeding phase. If the predetermined threshold is 0.25 [rad], feature amounts falling within the range of ±0.25 [rad] are determined as preceding/succeeding-phase feature amounts. In case of FIG. 15B, [preceding/succeeding-phase feature amount stored] is determined, and the process branch unit 1301 supplies an operation instruction to the preceding/succeeding-phase feature amount extraction unit 1304. When no data is stored within the predetermined threshold range with respect to the phase (3 [rad]) of the current frame, it is determined that neither in-phase feature amounts nor preceding/succeeding-phase feature amounts are stored. That is, in case of FIG. 15C, [no in-phase and preceding/succeeding-phase feature amounts stored] is determined, and the process branch unit 1301 supplies an operation instruction to the current frame feature amount extraction unit 1302. Note that feature amount information exemplified in the second embodiment has a configuration having a minimum value, intermediate value, and maximum value in an image in correspondence with phase information. The example of the feature amount information is not limited to such a specific example. In addition, the feature amount information may have all kinds of available information as feature amounts (for example, the information may include only a representative value in correspondence with phase information).

Steps S1431 to S1434 performed by the preceding/succeeding-phase feature amount extraction unit 1304 and current frame feature amount calculation unit 1305 will be described below. Upon reception of the operation instruction from the process branch unit 1301, the preceding/succeeding-phase feature amount extraction unit 1304 acquires feature amounts having a preceding/succeeding phase of the current frame from the feature amount storage unit 1306, and outputs the acquired feature amounts to the current frame feature amount calculation unit 1305 in step S1431.

In step S1432, the current frame feature amount calculation unit 1305 calculates the feature amounts of the current frame image based on the preceding/succeeding-phase feature amounts. As an interpolation arithmetic method of the current frame feature amounts, for example, various interpolation methods such as linear interpolation, nearest neighbor interpolation, polynomial interpolation, and spline interpolation can be used. In step S1433, the current frame feature amount calculation unit 1305 stores the feature amounts calculated in step S1422 in the feature amount storage unit 1306.

In step S1434, the current frame feature amount calculation unit 1305 outputs the calculated feature amounts to the image processing unit 1104, thus ending the processing. By executing the aforementioned processes in steps S1401 to S1434 as needed, the feature amount setting processing by the feature amount setting unit 1103 is complete.

According to this embodiment, a moving image that has undergone the image correction can have stable image quality while obtaining a processing speed high enough to implement the image correction of the moving image.

### Third Embodiment

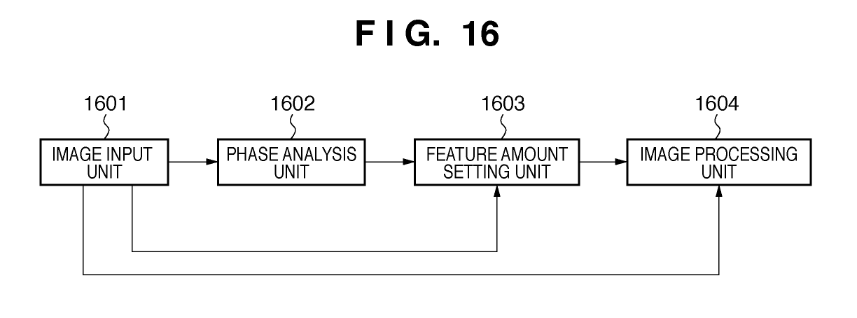

An overview of an image processing apparatus according to the third embodiment of the present invention will be described below with reference to the block diagram shown in FIG. 16. An image input unit 1601 accepts an external moving image input. A phase analysis unit 1602 receives frame images which form a moving image from the image input unit 1601, and analyzes a phase of a motion of a subject in a frame image to be processed (current frame image). A feature amount setting unit 1603 receives the current frame image from the image input unit 1601 and the phase analysis result from the phase analysis unit 1602, and sets feature amounts of the current frame image. An image processing unit 1604 receives the current frame image from the image input unit 1601 and the feature amounts of the current frame from the feature amount setting unit 1603, and applies image processing to the current frame image.

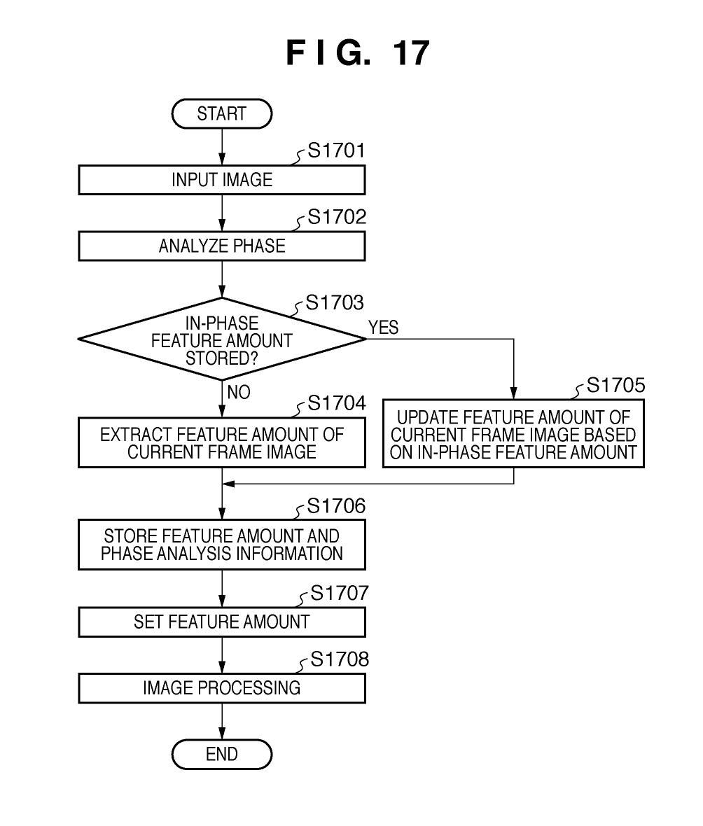

A series of processes to be executed by the image processing apparatus according to the third embodiment will be described below with reference to the flowchart shown in FIG. 17. Note that a control program of the image processing apparatus allows a computer to execute the processing sequence shown in the flowchart of FIG. 17. In step S1701, the image input unit 1601 accepts an input of the current frame image. In step S1702, the phase analysis unit 1602 receives the current frame image from the image input unit 1601, and analyzes the phase of an observation portion. The feature amount setting unit 1603 determines in step S1703 whether or not feature amounts set in phase with the current frame (in-phase feature amounts) have been stored from the imaging start timing until a timing before the acquisition timing of the current frame image. If in-phase feature amounts have been stored from the imaging start timing until a timing before the acquisition timing of the current frame image (Yes in S1703), the feature amounts of the current frame image are updated based on the in-phase feature amounts (S1705).

If no in-phase feature amounts have been stored from the imaging start timing until a timing before the acquisition timing of the current frame image (No in S1703), the feature amount setting unit 1603 extracts feature amounts of the current frame image from the current frame image (S1704). Since the in-phase feature amounts set before the acquisition timing of the current frame image are updated, the feature amount extraction precision can be improved. For this reason, even when simple image analysis is done, stable image quality can be obtained.

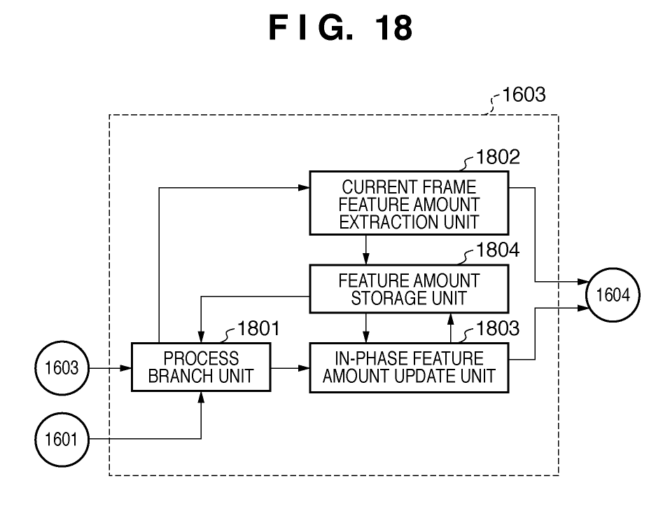

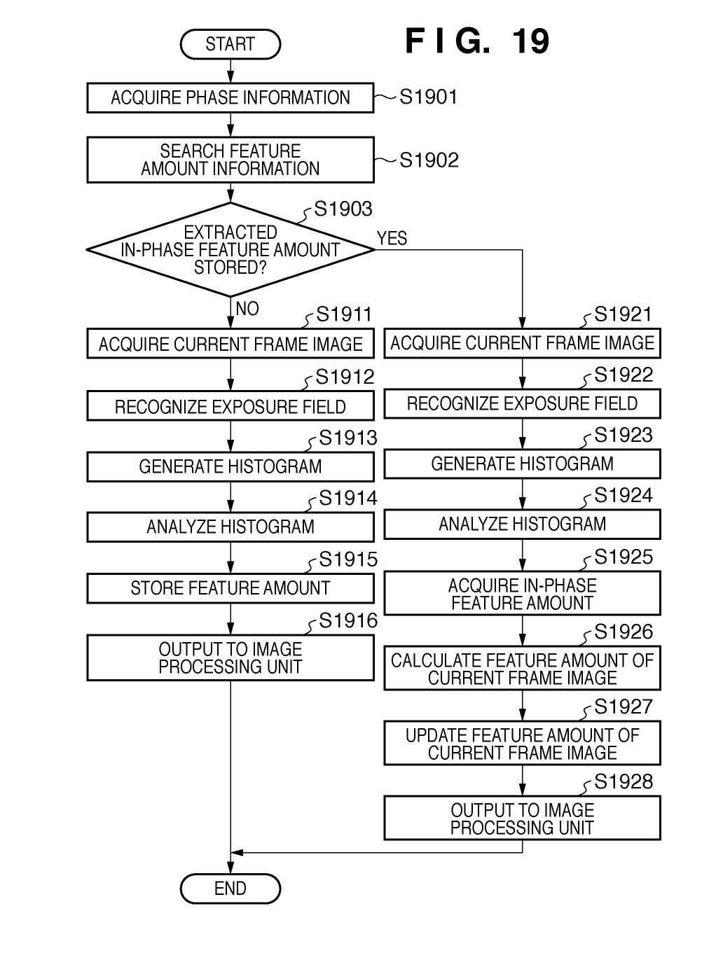

In step S1706, the feature amount setting unit 1603 stores the extracted or updated feature amounts. In step S1707, the feature amount setting unit 1603 sets the extracted feature amounts. Note that details of the feature amount setting method by the feature amount setting unit 1603 will be described later. In step S1708, the image processing unit 1604 applies image processing to the current frame image based on the set feature amounts. As for details of the image processing method by the image processing unit 1604, the same method as that by the image processing unit 104 of the first embodiment can be used. By executing the processes in steps S1701 to S1708, the series of processes of the image processing apparatus are complete. A series of processes by the feature amount setting unit 1603 will be described in detail below with reference to the block diagram shown in FIG. 18 and the flowchart shown in FIG. 19.

### Feature Amount Setting Unit 1603

The arrangement of the feature amount setting unit 1603 will be described below with reference to the block diagram shown in FIG. 18. A process branch unit 1801 distributes (branches) processes to be executed by the feature amount setting unit 1603 based on the phase information received from the phase analysis unit 1602. A current frame feature amount extraction unit 1802 extracts feature amounts of the current frame image. An in-phase feature amount update unit 1803 makes calculations for correcting and updating the feature amounts extracted from the current frame image using in-phase feature amounts acquired from a feature amount storage unit 1804. The feature amount storage unit 1804 stores the feature amounts obtained by the current frame feature amount extraction unit 1802 and in-phase feature amount update unit 1803.

A series of processes executed by the feature amount setting unit 1603 will be described below with reference to the flowchart shown in FIG. 19. At the timing of completion of steps S1901 to S1903 in FIG. 19, either processes in steps S1911 to S1916 to be performed by the current frame feature amount extraction unit 1802 or those in steps S1921 to S1928 to be performed by the in-phase feature amount update unit 1803 are executed. Since steps S1911 to S1916 executed by the current frame feature amount extraction unit 1802 are the same processes as in steps S411 to S416 described in the first embodiment, a description thereof will not be repeated.

In step S1901, the process branch unit 1801 receives phase information at the acquisition timing of the current frame image from the phase analysis unit 1602. In step S1902, the process branch unit 1801 searches feature amount information in the feature amount storage unit 1804 to determine whether or not feature amounts have been extracted from an image in phase with the current frame image from the imaging start timing until a timing before the acquisition timing of the current frame image. In step S1903, the process branch unit 1801 issues an operation instruction to one of the current frame feature amount extraction unit 1802 and in-phase feature amount update unit 1803 based on the determination result in step S1902.

Feature amount information in the feature amount storage unit 1804 will be exemplarily described below with reference to FIGS. 5A and 5B. Assuming that the phase of the current frame is 3 [rad], [in-phase feature amount stored] is determined in case of FIG. 5A, and the process branch unit 1801 supplies an operation instruction to the in-phase feature amount update unit 1803. On the other hand, [no in-phase feature amount stored] is determined in case of FIG. 5B, and the process branch unit 1801 supplies an operation instruction to the current frame feature amount extraction unit 1802.

Steps S1921 to S1928 executed by the in-phase feature amount update unit 1803 will be described below. Upon reception of the operation instruction from the process branch unit 1801, the in-phase feature amount update unit 1803 acquires the current frame image from the image input unit 1601 in step S1921. In step S1922, the in-phase feature amount update unit 1803 recognizes an exposure field irradiated with X-rays. Note that various methods about exposure field recognition have been proposed. For example, methods proposed by Japanese Patent Laid-Open Nos. 2000-271107 and 2003-33968 may be used.

In step S1923, the in-phase feature amount update unit 1803 generates a histogram of an image within the exposure field. In step S1924, the in-phase feature amount update unit 1803 analyzes the generated histogram and extracts feature amounts. Note that the histogram analysis method can use the same method as the histogram analysis method by the current frame feature amount extraction unit 302 described using FIG. 3.

In step S1925, the in-phase feature amount update unit 1803 acquires feature amount set in phase with the current frame image from the feature amount storage unit 1804. In step S1926, the in-phase feature amount update unit 1803 makes calculations required to update the feature amounts of the current frame image using the feature amounts extracted from the current frame image by the histogram analysis and the in-phase feature amounts acquired from the feature amount storage unit 1804. As the calculation method, for example, a method of averaging both the feature amounts may be used. Alternatively, when the in-phase feature amounts have already been set using a plurality of feature amounts of previous frames, the calculations may be made by weighting the in-phase feature amounts according to the number of setting times.

In step S1927, the in-phase feature amount update unit 1803 stores the feature amounts of the current frame image calculated in step S1926 in the feature amount storage unit 1804 to update the feature amounts of the current frame image. In step S1928, the in-phase feature amount update unit 1803 outputs the feature amounts of the current frame image calculated in step S1926 to the image processing unit 1604, thus ending the processing. By executing the aforementioned processes in steps S1901 to S1928 as needed, the feature amount setting processing by the feature amount setting unit 1603 is complete.

According to this embodiment, a moving image that has undergone the image processing can have stable image quality while obtaining a processing speed high enough to implement the image processing of the moving image.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-094365, filed Apr. 8, 2009, which is hereby incorporated by reference herein in its entirety.

What is claimed is:

1. An image processing apparatus for processing a moving image of a subject, comprising:
an input unit adapted to accept an input of a moving image of the subject;
an analysis unit adapted to analyze a phase of a motion of the subject based on a frame image of the moving image accepted by said input unit;
a determination unit adapted to determine based on the analysis result of said analysis unit whether or not feature amount information of a frame image in phase with the analyzed phase is stored in a storage unit;
a feature amount setting unit adapted to set the feature amount information in a frame image to be processed when it is determined based on the determination result of said determination unit that the feature amount information of the frame image in phase with the analyzed phase is stored in the storage unit; and
an image processing unit adapted to execute image processing for the frame image to be processed according to the feature amount information set by said feature amount setting unit.

2. The apparatus according to claim 1, wherein said feature amount setting unit comprises a feature amount calculation unit adapted to calculate a feature amount required to be set in the frame image to be processed by an interpolation operation based on the feature amount information stored in the storage unit, and
when it is determined based on the determination result of said determination unit that feature amount information of a frame image having a phase within a predetermined threshold range is stored in the storage unit, said feature amount setting unit sets the feature amount calculated by the interpolation operation in the frame image to be processed.

3. The apparatus according to claim 2, wherein said feature amount setting unit comprises a feature amount extraction unit adapted to extract the feature amount from the image to be processed, and
when it is determined based on the determination result of said determination unit that the feature amount information of the frame image in phase with the analyzed phase or having the phase falling within the predetermined threshold range is not stored in the storage unit, said feature amount setting unit sets the feature amount extracted by said feature amount extraction unit in the frame image to be processed.

4. The apparatus according to claim 3, wherein said feature amount setting unit acquires the feature amount information of the frame image in phase with the phase analyzed by said analysis unit from the storage unit, and updates the feature amount extracted by said feature amount extraction unit.

5. The apparatus according to claim 1, wherein the image processing executed by said image processing unit includes at least one of tone processing, sharpening processing for sharpening an edge of a subject image, and noise suppression processing, and
said image processing unit executes at least one of the tone processing, the sharpening processing, and the noise suppression processing according to the feature amount information set by said feature amount setting unit.

6. A method of controlling an image processing apparatus for processing a moving image of a subject, comprising:
an input step of accepting an input of a moving image of the subject;
an analysis step of analyzing a phase of a motion of the subject based on a frame image of the moving image accepted in the input step;
a determination step of determining based on the analysis result in the analysis step whether or not feature amount information of a frame image in phase with the analyzed phase is stored in a storage unit;
a feature amount setting step of setting the feature amount information in a frame image to be processed when it is determined based on the determination result in the determination step that the feature amount information of the frame image in phase with the analyzed phase is stored in the storage unit; and
an image processing step of executing image processing for the frame image to be processed according to the feature amount information set in the feature amount setting step.
